(19) United States
(12) Patent Application Publication
(10) Pub. No.: US 2011/0276350 A1
(43) Pub. Date: Nov. 10, 2011

(54) METHOD, DEVICE AND SYSTEM TO STORE, ACCESS, AND TRANSFER PERSONAL HEALTH RECORDS

(76) Inventor: Sanjaya Khanal, Lancaster, CA (US)

(21) Appl. No.: 13/143,888

(22) PCT Filed: Jan. 18, 2010
(86) PCT No.: PCT/US10/21328

§ 371 Date: Jul. 8, 2011

Related U.S. Application Data
(60) Provisional application No. 61/145,171, filed on Jan. 16, 2009.

(51) Int. Cl. G06Q 50/00; H04L 9/32

(52) U.S. Cl. 705/3

(57) ABSTRACT

A method, device and system to store, access, and transfer personal health records includes: a storage unit adapted to store the medical record; a biometric verification module to verify an identity of the person; and a communications interface; wherein the device shares the medical record utilizing the communications interface upon verification of the identity of the person. The device may encrypt the medical record for storage and decrypt the encrypted medical record for access. The biometric verification module may include a fingerprint scanner, retina scanner, or body part scanner. The communications interface may include a serial interface or a wireless interface.

### RELATED APPLICATIONS

This application claims the benefit of the filing date of U.S. Patent Application No. 61/145,171, filed Jan. 16, 2009, which is incorporated herein by reference in its entirety.

### BACKGROUND OF THE INVENTION

The present invention generally relates to medical records storage, and more specifically to a system to store, access, and transfer personal health records.

Electronic medical and health records improve efficiency and avoid errors in care of patients. They are increasingly used in hospitals and physician offices. The US government also has set a goal to transition to electronic medical records to improve efficiency, reduce errors, duplication of tests, and therefore reduce overall health care costs. Currently, there are many providers with different types of electronic medical record products. Unfortunately, most products are not compatible with each other. Records stored in one format cannot be easily retrieved by a health care professional using another product. The storage of the records is also cumbersome and doesn't give easy access to patients and providers who need the right information on site to provide care. This leads to poor communication between patient providers, inefficient patient care, duplication of tests, and errors in providing appropriate care. Putting patient records in central repositories and providing access through the internet has been proposed as one means of improving the current situation. However, these internet repositories are susceptible to unauthorized access. Therefore, most patients will not be comfortable with their most vital and secret information stored this way.

It would be desirable to have a device that transfers personal health records.

### SUMMARY OF THE INVENTION

In one aspect of the present invention, a device for sharing a medical record of a person includes: a storage unit adapted to store the medical record; a biometric verification module to verify an identity of the person; and a communications interface; wherein the device shares the medical record utilizing the communications interface upon verification of the identity of the person.

In another aspect of the present invention, a system for communicating between a first medical provider and a second medical provider includes: a storage unit adapted to store a medical record; a biometric verification module that verifies an identity of an owner of the medical record; and a communications interface; wherein, upon verification of the identity of the owner, the system utilizes the communications interface to accept data from the first medical provider, stores the data as the medical record on the storage unit, and provides the data to the second medical provider.

In yet another aspect of the present invention, a method for sharing a medical record of a person includes: storing the medical record on a storage unit; utilizing a biometric verification module to verify an identity of the person; and sharing the medical record upon verification of the identity of the person.

### BRIEF DESCRIPTION OF THE DRAWINGS

FIG. 1 is a block diagram of an embodiment of the present invention;

FIG. 2 is a flowchart of an embodiment of the present invention;

FIG. 3 is a drawing of a storage device according to the present invention; and

FIG. 4 is a diagram showing an exemplary embodiment of the interaction of components according to the present invention.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a method, device and system to store, access, and transfer personal health records.

An embodiment of the present invention includes a method, device, and system to store, access, and share medical records that may be inexpensive, efficient, highly secure, and controlled only by patients and their providers. A component may include a proprietary data storage device that can store patient data. This device may communicate with electronic medical record systems in physicians' offices or hospitals either through a wired or wireless connection to synchronize and transfer data to and from the systems. It may check for any new records and update both ways each time the patient visits a health care provider. A secure biometric system (e.g., a fingerprint or retina scanner) may be installed on the device. Software and computer hardware may be used to facilitate communication and sharing of data between the patient's device and provider systems.

An embodiment may include a method, device, and system to store, access, and share medical records that would be inexpensive, efficient, highly secure, and controlled only by patients and their providers. It consists of various components. One component may include a proprietary data storage device (e.g., a card like a credit card) that can store patient data. This device may communicate with electronic medical record systems in physicians' offices or hospitals either through a wired (e.g., a universal serial bus USB port) or wireless (e.g., Bluetooth or radiofrequency) connection to synchronize and download data to and from the systems. The system may check for new records and update both ways each time the patient visits the health care provider. A secure biometric system (e.g., a fingerprint or retina scanner) may be installed on the device. The data can be synchronized and transferred when the patient personally uses this biometric scan to activate the card. After the transfer/download of records, both the device and the provider's medical record system will have the patient's data that can be accessed and used. After the encounter, the patient keeps the device until another provider encounter. This way, the patient owns all his/her records and can decide who can or cannot have access to it. The individual patient can also open the data in the card through a personal computer and customize options to share different kinds of data to different providers. Since the patient carries this device all the time, all their medical records can be accessed and securely transferred when visiting a new provider. Software and a hardware device to synchronize and download records may be attached to providers' electronic medical systems to be able to communicate with the patient device. The software may automatically search for patient data and create files to download the medical records in pre-specified formats into the provider's electronic medical systems for easy retrieval. Therefore, the system may provide a total solution for efficient and confidential storage, transfer, and retrieval of personal medical records that is controlled by patients and their providers.

An embodiment of the present invention may include a data storage device. It can be a card like a credit card or installed into any mobile equipment. It has three basic functions: data storage in an encrypted format; providing access to the data using biometric verification (e.g., a fingerprint); and communication capability (wire connected e.g., USB port or wireless e.g., Bluetooth, or radiofrequency).

In an embodiment, other components include software and hardware installed into a provider's medical record storage devices (such as computers). The hardware may recognize the personal record storage device using either a direct or wireless connection. It then synchronizes and downloads records both into the personal device and provider's storage device in a retrievable format. The software loaded in each retrieving device will decrypt the patient data and download the data into the provider's computer in a viewable format. An embodiment of this same retrieving system may be installed into patients' personal computers as well as the computers of larger providers like hospitals for rapid download, exchange, and viewing personal health records.

To use an embodiment, the personal record storage device is owned and carried by the patient all the time. When the patient is admitted to a hospital and discharged, all hospital records are downloaded into patient's personal device and given to the patient. When the patient visits a provider, e.g., a physician, the patient presents this device. The hardware in the physician's office recognizes the device after patient activates it through personal biometric permission. The software in the physician's computer synchronizes and downloads the data stored in the personal device into the physician's medical records. The physician sees the data, uses them and adds more to the patient record based on the encounter. At the end of the visit, another synchronization is done so that the new data is also downloaded into the personal storage device. The patient retains this device for further provider encounters. The patient can also use a personal computer (equipped with the appropriate hardware and software) to view the stored data.

In an embodiment, the data storage device is sometimes inactive and not accessed until the owner uses a personal biometric scan to activate it. In an activated state, other storage devices (loaded with the described hardware and software) connect to the device, synchronize and download new data that exists in each of the systems for the patient.

An embodiment of this invention may be made by providing a data storage device that can store personal data in encrypted format, get activated by using personal biometrics, and connect to other devices using either wired or wireless connections. A hardware that recognizes and connects to the storage device and software to facilitate the recognition, synchronization, and transfer or data may be included.

In an embodiment, the storage device is separate equipment. In other embodiments, the storage device may be installed as a component of a mobile device that the patient can carry, or be implanted into the body (such as a pacemaker, for example). The connection between the devices can be made by wire contact or wireless communication like Bluetooth, radiofrequency or any other communication technology.

In an embodiment, each individual will own a personal medical records storage device. This will have all necessary personal and health information stored in it. When the individual presents to a personal care provider, the device is produced and activated using personal biometrics (e.g. fingerprint). The provider will then connect to the device and synchronize and download any new health data into the provider's computer for review. Any new record generated by the provider will also be downloaded into the device. The data in the device can also be visualized by the individual's personal computer following access rules established for different provider encounters. For example, the patient may want to block access to certain medical information to health insurance companies for privacy reasons.

An embodiment includes the use of biometric-protected personal data to store, synchronize, download, and view individual records can also be used in other fields than healthcare such as job search organizations, insurance companies, and security organizations.

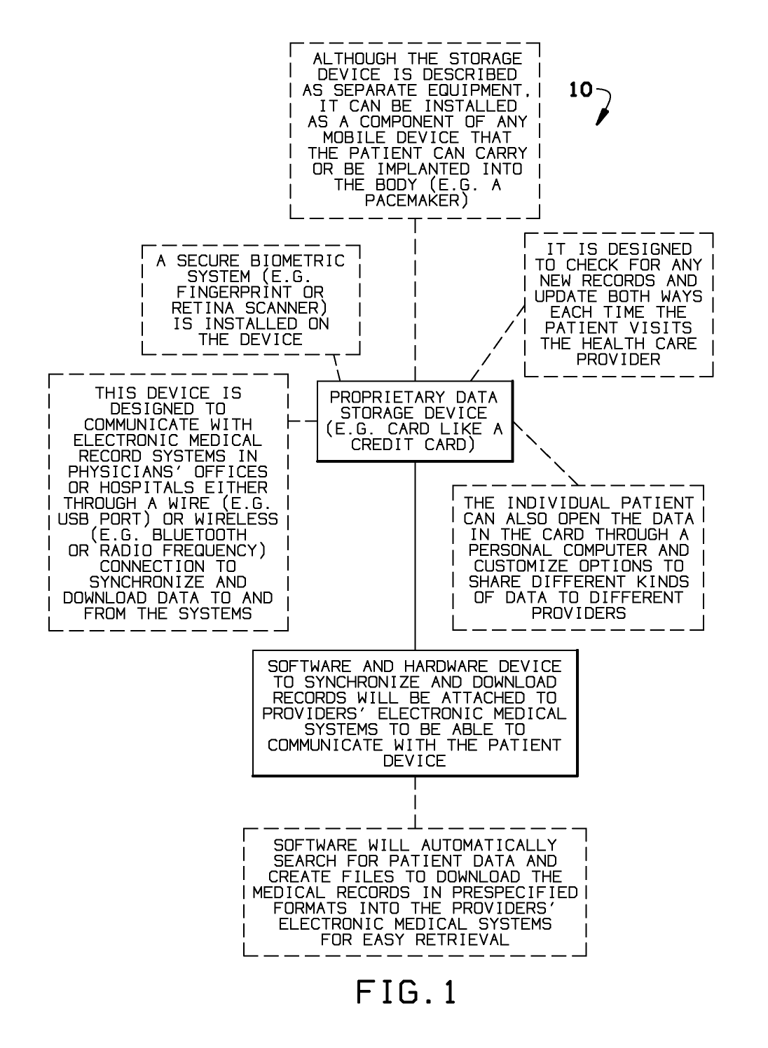

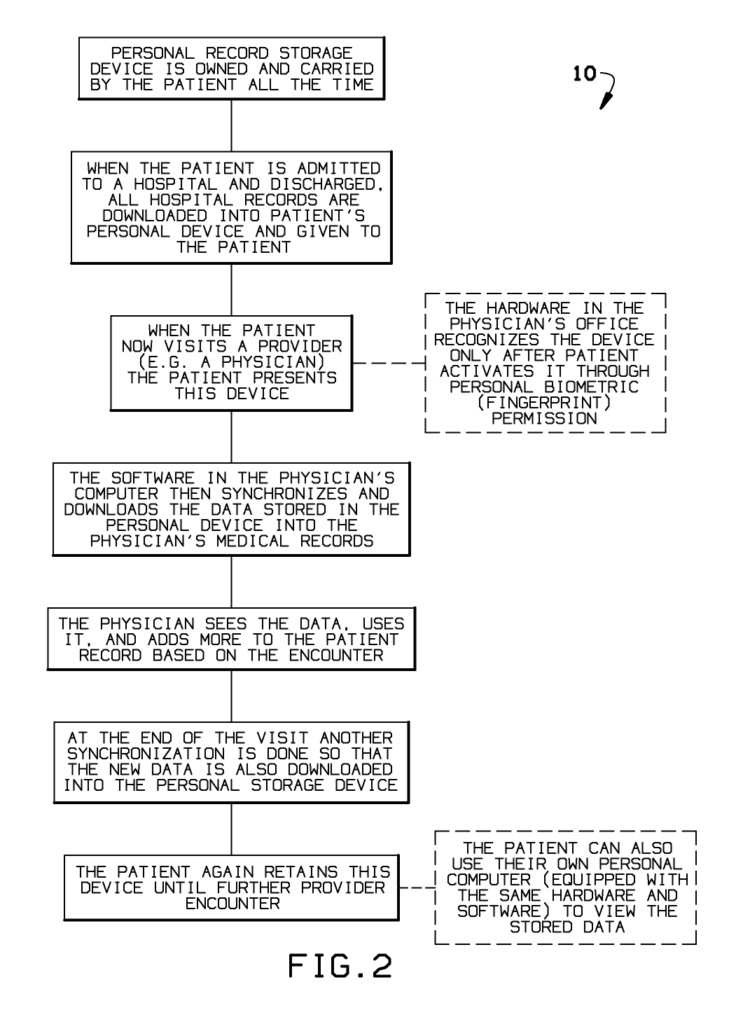

FIG. 1 depicts a block diagram of an embodiment of the present invention 10, and FIG. 2 depicts a flowchart of an embodiment of the present invention 10.

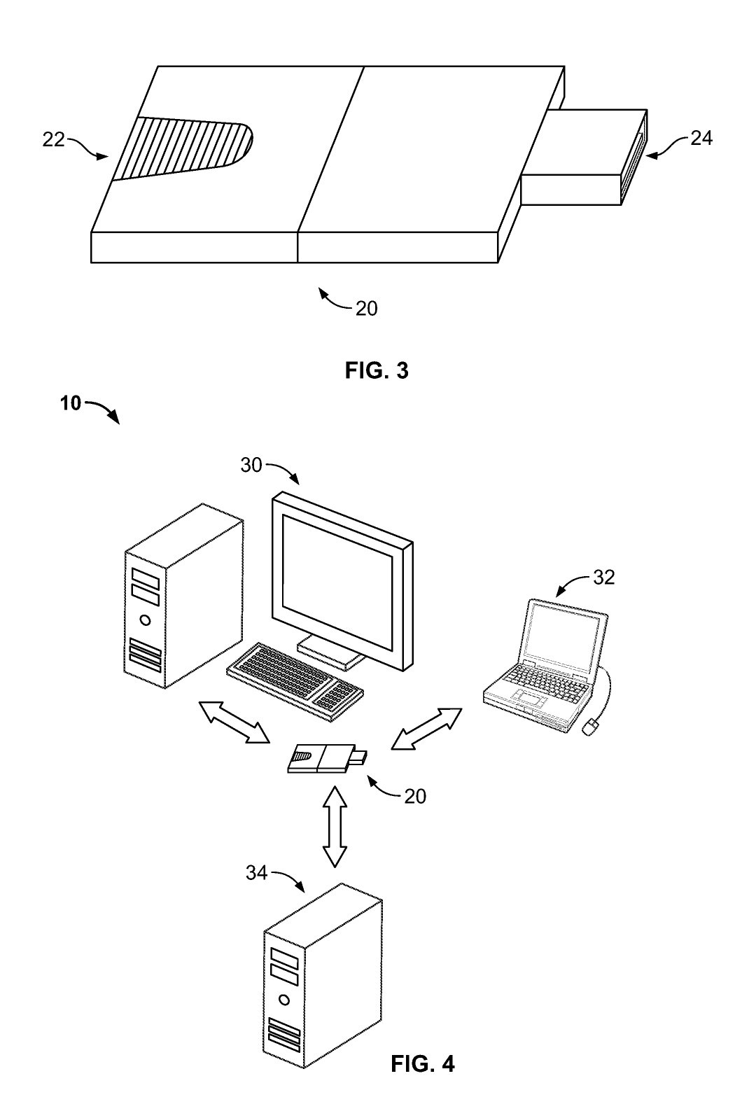

FIG. 3 is a drawing of a storage device 20 according to the present invention. This includes an input 22 from a scanner, such as a finger print or retina, and a communications port 24 such as a USB, Ethernet/Internet, Wi-Fi, Bluetooth, or other radio frequency wireless communicator.

FIG. 4 is a diagram showing an exemplary embodiment of the interaction of components according to the present invention 10. A provider computer 30 for persons who need the information on site interfaces with the storage device 20. The individual patient may also access the data in the card 20 through a personal computer 32. An institution server 34, such as a computer at a hospital, also accesses the storage device 20.

1. A device for sharing a medical record of a person, comprising:
a secure biometric system to obtain biometric data from the person;
a biometric verification module to verify an identity of the person utilizing the biometric data;
an encryption module to encrypt the medical record for storage utilizing the biometric data;
a mobile storage unit to store the encrypted medical record;
a decryption module to decrypt the encrypted medical record for access utilizing the biometric data; and
a communications interface;
wherein, upon biometric verification of the identity of the person, the device initiates sharing of the medical record utilizing the communications interface.

2. The device of claim 1, wherein the device encrypts the medical record for storage and decrypts the encrypted medical record for access, thereby storing the medical record in encrypted form and sharing the medical record in unencrypted form.

3. (canceled)

4. The device of claim 1, wherein the device is adapted to be implanted into a body of the person, and the biometric verification module verifies the identity of the person into which the module is implanted.

5. The device of claim 1, wherein the storage unit is adapted to be accessed by a computer, and upon verification of the identity of the person, to transfer the medical record to the computer.

6. The device of claim 1, wherein the storage unit is adapted to be accessed by a medical provider having electronic medical record storage, and the device transfers the medical record to the medical provider's electronic medical record storage upon verification of the identity of the person.

7. The device of claim 1, wherein:
the storage unit is adapted to be accessed by a first medical provider, so as to store the medical record on the storage unit upon a first verification of the identity of the person; and
the storage unit is adapted to be accessed by a second medical provider, so as to retrieve the medical record from the storage unit upon a second verification of the identity of the person.

8. The device of claim 7, wherein the first medical provider has a first physical location, the second medical provider has a second physical location, and the first physical location is different from the second physical location.

9. The device of claim 7, wherein the device synchronizes the medical record stored on the device with a record stored outside of the device by the second medical provider.

10. The device of claim 1, wherein the biometric verification module includes a fingerprint scanner.

11. The device of claim 1, wherein the communications interface includes a Wi-Fi interface.

12. The device of claim 1, further comprising:
a module that checks for updated or new records on the storage unit, and when an updated or new record is found, the device transmits the updated or new record utilizing the communications interface.

13. (canceled)

14A. (canceled)

15A. (canceled)

14. A method for sharing a medical record of a person, comprising:
obtaining biometric data from the person;
verifying an identity of the person utilizing the biometric data;
encrypting the medical record for storage utilizing the biometric data;
storing the encrypted medical record on a mobile storage unit;
decrypting the encrypted medical record for access utilizing the biometric data; and
upon biometric verification of the identity of the person, initiating sharing of the medical record.

15. The method of claim 14, further comprising:
utilizing a communications interface, upon verification of the identity of the person, to receive the medical record from a first provider and to provide the medical record to a second provider.

16. The method of claim 14, further comprising:
utilizing a Wi-Fi interface to communicate the medical record from the storage unit to a medical provider.

17. The method of claim 14, further comprising:
receiving the medical record from a first medical provider having a first physical location; and
providing the medical record to a second medical provider having a second physical location.

18. (canceled)

19. (canceled)

20. The method of claim 14, further comprising:
implanting the device into a body of the person.

21. The device of claim 1, wherein the biometric verification module includes a retina scanner.

22. The device of claim 1, wherein the biometric verification module includes a body part scanner.

23. The device of claim 1, wherein, upon biometric verification of the identity of the person, the device decrypts a first medical record stored in the storage unit, communicates the decrypted first medical record utilizing the communications interface, receives a second medical record utilizing the communications interface, synchronizes the first and second medical records to provide a synchronized medical record, encrypts the synchronized medical record, and stores the encrypted, synchronized medical record in the storage unit, thereby sharing the medical record.

24. The method of claim 14, further comprising: upon biometric verification of the identity of the person, decrypting a first medical record stored in the storage unit, communicating the decrypted first medical record utilizing the communications interface, receiving a second medical record utilizing the communications interface, synchronizing the first and second medical records to provide a synchronized medical record, encrypting the synchronized medical record, and storing the encrypted, synchronized medical record in the storage unit, thereby sharing the medical record.
